(19) United States
(12) Patent Application Publication
(10) Pub. No.: US 2017/0285446 A1
(43) Pub. Date: Oct. 5, 2017

(54) FILTER HOLDER

(71) Applicant: TPL VISION, La Chevroliere (GB)

(72) Inventor: Guillaume MAZEAUD, Glencarse (GB)

(73) Assignee: TPL VISION, La Chevroliere (GB)

(21) Appl. No.: 15/459,511

(22) Filed: Mar. 15, 2017

(30) Foreign Application Priority Data
Mar. 15, 2016 (FR) 16 52164

(51) Int. Cl. G03B 17/56; G02B 7/00; G03B 11/00

(52) U.S. Cl. CPC G03B 17/565; G03B 11/00; G02B 7/006

(57) ABSTRACT

Filter holder (10) having a tubular overall shape and made of an elastic material, an annular groove (40) being formed on the interior surface of the filter holder.

### TECHNICAL FIELD

The invention relates to a filter holder that can be fitted to different photographic lenses.

### PRIOR ART

It is conventional practice to fit filters at the free end of the photographic lenses of photographic equipment or cameras. These filters are conventionally screwed onto this free end of the photographic lens. It is therefore necessary to have a filter for each diameter of photographic lens.

Moreover, when a photographic lens is subjected to recurrent vibrations, for example because it is arranged in an industrial environment, the various components of which it is formed have a tendency to come apart. In particular, the photographic lens conventionally comprises screws which have a tendency to work loose. Finally, the rings used to adjust the photographic lens have a tendency to turn, thereby reducing the quality of the image. It is an object of the invention to at least partially solve these problems.

### SUMMARY OF THE INVENTION

According to the invention, this objective is achieved by means of a filter holder having a tubular overall shape and made of an elastic material, an annular groove being formed on the interior surface of the filter holder.

As will be seen in greater detail in the remainder of the description, the elasticity of the filter holder allows it to be fixed, removably, to photographic lenses of different diameters. Furthermore, the filter holder can be mounted on a photographic lens in such a way that the groove extends beyond the free end of the photographic lens. A filter can therefore be placed in the groove. The elasticity of the material also allows the filter to be held in position. Finally, the elasticity of the material allows the groove to accommodate filters of different diameters.

A filter holder according to the invention may also comprise one or more of the following optional features:
A filter holder according to the invention may be made from an elastic material chosen so that, from a rest positon, the smallest interior diameter of the filter holder can be widened by more than 5%, preferably more than 7%, preferably more than 10%.
The annular groove of the filter holder may extend less than 20 mm, preferably less than 10 mm, preferably less than 5 mm from a distal end of the filter holder.
The filter holder may comprise a skirt delimited by an annular thinning, so as to be mobile between the deployed and bunched positions in which it extends on one side or the other of the said annular thinning, respectively.
The filter holder may comprise a bellows allowing the diameter of the annular groove to be enlarged so that a filter could be housed therein, preferably substantially without deformation of the filter holder the opposite side of the said bellows to the said annular groove.
The annular groove may have a width greater than 1 mm and less than 5 mm.
The filter holder may be made of a single elastic material, the elasticity of the said material allowing the resting diameter of the annular groove to be increased by more than 1 mm, preferably by hand.
The smallest interior diameter of the filter holder at rest may be greater than 20 mm, preferably greater than 25 mm and/or less than 35 mm, preferably less than 30 mm.

The invention also relates to an assembly comprising a filter holder according to the invention and one or more photographic equipment or camera photographic lenses of different diameters and on which the filter holder may be mounted and/or one or more filters that may be mounted on the filter holder.

### BRIEF DESCRIPTION OF THE FIGURES

Further features and advantages of the invention will become further apparent from reading the detailed description which will follow and from studying the attached drawing in which FIGS. 1 and 2 depict a filter holder according to the invention in a service position in which it is fixed to a photographic lens, the skirt being in the deployed position and in the bunched position respectively.

The filter holder is depicted in longitudinal section.

To improve the clarity of the drawing, the outlines of the photographic lens have been depicted in thick line.

FIG. 3 depicts, in a view from above and in longitudinal section, one exemplary filter holder according to the invention, in a preferred embodiment. The dimensions are in millimetres.

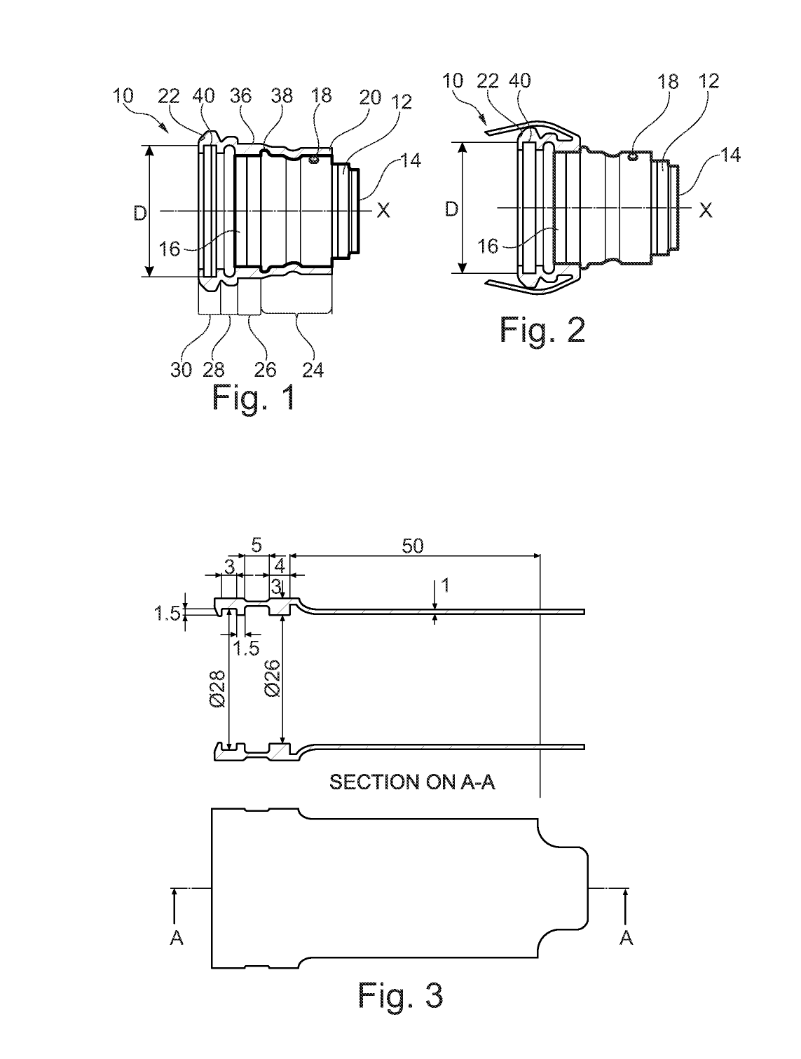

### DETAILED DESCRIPTION

FIG. 1 depicts a filter holder 10 according to the invention mounted on a photographic lens 12 of cylindrical overall shape of axis X. The photographic lens 12, which is removable, comprises a proximal end 14 intended to be fixed to the body of a piece of photographic equipment or of a camera, and a free distal end 16 which, conventionally, carries an optical lens. The photographic lens is conventionally fitted to the body of the photographic equipment or of the camera by means of a bayonet system.

Conventionally, a photographic lens comprises various components fixed together using screws the heads 18 of which lie flush with the lateral surface of the photographic lens 12. The filter holder 10, in the form of a sleeve, extends from a proximal end 20 as far as a distal end 22, along the axis X, over a length preferably greater than 30 mm, than 50 mm, than 60 mm and/or less than 150 mm, 100 mm, 80 mm. The smallest interior diameter of the sleeve is preferably greater than 20 mm, than 25 mm, and/or less than 40 mm, than 35 mm, than 30 mm. It comprises, from the proximal end 20 as far as the distal end 22, a thin and flexible skirt 24, a more rigid fixing part 26, and then, beyond the distal end 16 of the photographic lens, an annular bellows 28 and a filter support 30.

For preference, the length of the skirt 24, along the axis X, is greater than 20 mm, than 30 mm, than 40 mm, and/or less than 80 mm, than 70 mm, than 60 mm, a length of 50 mm being highly suitable.

For preference, the fixing part 26 has a thickness greater than 2 mm, preferably greater than 3 mm. For preference, it comprises on the inside an annular bearing surface 36 which, after assembly with the photographic lens, compresses a corresponding surface of the photographic lens so as to hold the filter holder firmly on the photographic lens.

For preference, the length of the fixing part 26, along the axis X, is greater than 2 mm, greater than 3 mm, preferably around 4 mm.

The skirt 24 preferably has a thickness less than 2 mm, preferably less than 1.5 mm. At the junction with the fixing part 26, the skirt 24 preferably has a thinning 38, preferably annular, acting as a hinge. The skirt 24 is mobile between deployed and bunched positions depicted in FIGS. 1 and 2 respectively, in which it extends on the proximal side and on the distal side of the thinning 38, respectively.

In the deployed position, the skirt may advantageously cover the screwheads 18, and thus prevent any working loose. Furthermore, the elasticity of the skirt 24 advantageously allows the other components of the photographic lens that it covers to be held in position, particularly the rings used to adjust the optics.

In the bunched position, the screwheads 18 are accessible for disassembly if required and the various components of the optics, and notably the rings, may be moved, particularly by rotation about the axis X.

The filter support 30 comprises an annular groove 40, preferably of axis X, the diameter of which can be enlarged because of the elasticity of the filter holder.

The width of the annular groove 40 is preferably greater than 1 mm, preferably greater than 2 mm and/or less than 5 mm, preferably less than 4 mm, preferably around 3 mm. Its interior diameter at rest D, which means to say in the absence of a filter, is preferably greater than 25 mm, preferably greater than 26 mm, preferably greater than 27 mm and/or less than 35 mm, preferably less than 33 mm, preferably less than 31 mm, an at rest diameter of around 28 to 30 mm being highly suitable.

The bellows 28 is deformable so as to allow a filter to be inserted into the groove 40 without substantial detachment of the fixing part.

For preference, the filter holder according to the invention is made of a single material, making it easier to manufacture. For preference, it is of one piece. For preference, it has no weld region.

Any elastic material may be used to manufacture a filter holder according to the invention, for example an EPDM (ethylene-propylene-diene monomer).

For preference, the elasticity of the material of which the filter holder is made makes it possible, preferably by hand, which means to say without a tool, to increase the at rest interior diameter D of the groove 40 and/or the at rest interior diameter of the fixing part 26 and/or the smallest interior diameter at rest of the skirt 24, by more than 1 mm, preferably more than 2 mm, preferably more than 3 mm, preferably more than 4 mm, without tearing.

For preference also, the material of which the filter holder is made is opaque. In a preferred embodiment, the filter holder carries advertising.

A filter holder according to the invention is mounted on a photographic lens preferably as follows:

The skirt 24 is placed in the bunched position and the fixing part is enlarged so as to be able to accept the distal end of the photographic lens. Releasing the tension on the fixing part brings the bearing surface 36 into close contact with the photographic lens, thereby firmly holding the filter holder on the photographic lens.

The skirt 24 is then deployed so that it comes into close contact, because of the elasticity of the material, with the exterior surface of the photographic lens, as depicted in FIG. 1.

A filter, not depicted, can then be inserted into the groove 40.

What is meant by “filter” is a device intended to be placed in front of a photographic lens of photographic equipment or of a camera. A filter may notably serve to modify the wavelengths of the incident rays, but may also serve to deflect these rays. A filter in the sense of the present invention also includes a transparent material affording protection to the optics of the photographic lens or partially masking same.

More specifically, the filter support 30 is deformed in such a way as to facilitate the insertion of the filter into the said groove. The presence of the bellows 28 facilitates this deformation while at the same time preventing the fixing part and the photographic lens from becoming detached from one another. The reverse manoeuvre allows the filter to be detached, and possibly replaced by a second filter.

If the photographic lens is subjected to vibrations, the skirt prevents any modification of the angular position of the rings of the photographic lens and any working loose of the screws which lie flush with the surface thereof.

If the setting of the photographic lens needs to be modified, the skirt 24 can be repositioned in the bunched position without it being necessary to disassemble the filter holder or the filter. The setting may then be modified, particularly by turning one or more rings of the photographic lens. The skirt 24 can then be returned to the deployed position. As is now clearly apparent, a device according to the invention can advantageously be fitted to several diameters of photographic lens and is suited to various diameters of filter. Furthermore, it effectively maintains the setting of the photographic lens and prevents screws from working loose under the effect of vibrations. Finally, the filter holder, preferably made of one piece, is easy to manufacture and low in cost.

Of course, the invention is not restricted to the embodiment described and depicted, which is provided for illustrative purposes only.

1. Filter holder having a tubular overall shape and made of an elastic material, an annular groove being formed on the interior surface of the filter holder, the filter holder comprising a skirt delimited by an annular thinning, so as to be mobile between deployed and bunched positions in which it extends on one side or the other of the annular thinning, respectively.

2. Filter holder according to claim 1, the elastic material being chosen so that, from a rest position, the smallest interior diameter of the filter holder can be widened by more than 5%.

3. Filter holder according to claim 1, in which the annular groove extends less than 20 mm from one end of the filter holder.

4. Filter holder according to claim 1, comprising a bellows allowing the diameter of the annular groove to be enlarged so that a filter can be housed therein.

5. Filter holder according to claim 1, in which the annular groove has a width greater than 1 mm and less than 5 mm.

6. Filter holder according to claim 1, the filter holder being made of a single elastic material, the elasticity of the material allowing the resting diameter of the annular groove to be increased by more 1 mm.

7. Filter holder according to claim 1, of which the smallest interior diameter at rest is greater than 20 mm.

8. Assembly comprising: a filter holder according to claim 1 and several filters of different diameters and configured to be arranged in the annular groove of the filter holder and/or several photographic lenses of different diameters and on which the filter holder may be mounted.

9. Filter holder according to claim 2, wherein the filter holder can be widened by more than more than 7%.

10. Filter holder according to claim 2, wherein the filter holder can be widened by more than more than 10%.

11. Filter holder according to claim 3, in which the annular groove extends less than 10 mm from one end of the filter holder.

12. Filter holder according to claim 3, in which the annular groove extends less than 5 mm from one end of the filter holder.

13. Filter holder according to claim 4, wherein the diameter of the annular groove is able to be enlarged so that a filter can be housed therein substantially without deformation of the filter holder on the opposite side of the bellows to the annular groove.

14. Filter holder according to claim 6, the filter holder being made of a single elastic material by hand.

15. Filter holder according to claim 7, of which the smallest interior diameter at rest is greater than 25 mm and/or less than 35 mm.

16. Filter holder according to claim 7, of which the smallest interior diameter at rest is less than 30 mm.
